(19) United States
(12) Patent Application Publication
(10) Pub. No.: US 2017/0259373 A1
(43) Pub. Date: Sep. 14, 2017

(54) Method and Apparatus for Joining Workpieces at a Lap Joint

(71) Applicant: Scansonic MI GmbH, Berlin (DE)

(72) Inventors: Florian ALBERT, Berlin (DE); Peter FIXEMER, Berlin (DE); Igor HASCHKE, Berlin (DE); Alexander MULLER, Berlin (DE); Pravin SIEVI, Berlin (DE)

(21) Appl. No.: 15/529,093

(22) PCT Filed: Nov. 23, 2015
(86) PCT No.: PCT/DE2015/100496

§ 371 Date: May 24, 2017

(30) Foreign Application Priority Data
Nov. 24, 2014 (DE) 10 2014 117 157.8

(51) Int. Cl. B23K 26/044; B23K 26/242; B23K 31/12; B23K 26/03; B23K 26/082; B23K 26/046

(52) U.S. Cl. CPC B23K 26/044; B23K 26/082; B23K 26/046; B23K 31/125; B23K 26/032; B23K 26/242; B23K 2203/04

(57) ABSTRACT

A method and an apparatus for joining two workpieces by means of a processing beam by forming a weld seam along a lap joint, wherein a gap formed at the lap joint between the two workpieces is filled during welding. The processing beam performs a spatial oscillatory movement parallel and/or perpendicular to the joint during welding. The oscillation parameters of said oscillation, the feed rate, the power of the processing beam and the angle of incidence of the processing beam onto the surfaces of the workpieces are adjusted dynamically during the welding process such that the upper sheet is fused in line with demand and the melt flows from the upper sheet down to the lower sheet thus closing the gap. The gap height is measured permanently during welding and the process parameters are adjusted such that a reliable closing of the gap is made possible.

### CROSS REFERENCE TO RELATED APPLICATIONS

This application is the U.S. national stage of International Application No. PCT/DE2015/100496,filed on 2015-11-23. The international application claims the priority of DE 102014117157.8filed on 2014-11-24; all applications are incorporated by reference herein in their entirety.

### BACKGROUND

1. Field of the Disclosure

The invention relates to a method for joining a first and a second workpiece of a similar material, in particular of aluminum or a high-strength steel material, or of workpieces of dissimilar metallic materials to a component by means of a continuously emitting processing beam by forming a weld seam along a lap joint. By filling a gap formed between the workpieces at the lap joint, the weld seam quality is improved. The invention also relates to an apparatus for joining workpieces by forming a weld along a lap joint.

2. Description of the Related Art

During the welding process by means of a processing beam, for example by means of a laser, a weld pool is produced at the point where the processing beam hits the workpieces to be joined. The shape of the weld pool (width, length) is characterized by the speed of the relative movement between the processing beam and the workpieces, the properties of the processing beam and, to a great extent, by the workpieces to be joined. Homogeneous weld courses typically resulted in the formation of a uniform weld pool, i.e., the size of the weld pool was constant during the welding process. Changes in the weld seam path (gap between the workpieces at the joint, changed speed of the relative movement and heat dissipation), however, cause changes in the size of the weld pool.

Deep welding requires very high power densities of about 1 megawatt per square centimeter. In this case, the processing beam not only melts the metal, but also generates steam. Thus, a deep, narrow, vapor-filled hole is formed in the metal melt: the so-called vapor capillary or also called keyhole. The vapor capillary is the result of an equilibrium between the pressure of the evaporating material on the one hand and the surface tension and the gravitational force acting on the melt on the other hand, both acting against the vapor pressure to close the vapor capillary. The vapor capillary also affects the quality of the weld.

A change in the weld pool size in the course of the welding process and in particular the effects of the vapor capillaries, which are subject to high dynamics, can result in a superposition of the natural oscillations, which are dependent on the size of the weld pool, at distinct points on the surface of the weld pool thus leading to the occurrence of so-called “melt waves”.

The demands on component quality are increasing permanently. Particularly in the automotive sector, there is the requirement to combine quality and mass production. The quality of a seam is defined at the seam top by means of the seam anmutung (sleekness, flatness), at the seam bottom by means of the seam overhang, as well as the mechanical load bearing capacity (cross section, form, edge notches) and the tightness (closed seam).

When joining workpieces by means of a processing beam an undefined, varying gap always will be present between the two workpieces to be joined - in spite of a great efforts involved in the preparation of the workpieces, starting with the design of the component, the pressing, the logistics, the clamping technique and the welding sequence as well as the joining itself. This problem in particular holds for the high-strength steel materials, which are becoming more and more widespread. High-strength steel materials are cured during the forming process. In the subsequent joining stations, the gaps resulting from the positioning of the high-strength workpieces cannot be eliminated even when applying high contact pressure forces. A further aggravating aspect concerns the heat introduced into the components by the joining process, which leads to a heat distortion. In the cold state the components may have a zero gap while only during introduction of heat a gap arises which is invisible to the production and therefore cannot be compensated. In particular, highly automated operation may result in undefined gaps. These have to be detected and corrected immediately in the joining process in order to meet the increasing quality requirements.

Processes and devices for the joining (e.g. welding or soldering) of workpieces (for example sheet metal) by means of a laser beam are known from the prior art, in which during welding an additional material is applied in the form of a wire to the weld to be produced, in particular to be able to fill a gap between the two workpieces to be welded. DE 196 10 242 A1 describes such a method, wherein an additional material is added to the weld pool at the joint at a position behind the laser spot with respect to the feed direction. By applying additional material, however, long cycle times are involved, which slows down the process significantly. This in turn contradicts efficient mass production.

It is also known that a gap between two workpieces, which prior has to be measured, can be closed by an adjustment of laser process parameters. DE 38 20 848 A1 and DE 38 44 727 C2 describe a method to join workpieces by means of a laser beam, wherein the height difference between the edges of the two workpieces adjacent to the joint is adapted as a function of the height difference such that the gap is being closed either by additional material to be molten by the laser beam or by molten material created by enhanced melting of a workpiece. The measurement of the height difference is performed by using a short-term non-shielded plasma generated by the laser beam.

DE 10 2004 043 076 A1 reveals a method for joining workpieces at a lap joint using a laser beam, wherein the height of the gap between the top and bottom sheet metals is measured with a camera system and the course of the laser beam spot on the workpieces is varied according to the gap height by adjusting the amplitude of a pendulum movement of the laser beam so that sufficient material is melted away from the top sheet for closing the gap. An increase in energy input into the top sheet, however, is reducing the processing speed, since by increasing the amplitudes of the pendulum movement the fade rate consequently is reduced due to an increased time required for melting.

In particular, the increasing spreading of aluminum and press-hardened, high-strength steel materials in vehicle construction does not permit a variation in the height of the gap formed between the workpieces to be joined, since the process window is already relatively small in the case of aluminum or since it is technically not possible with cured materials to press them in a defined—for the process—small gap situation.

The absorption rate at room temperature of laser light emitted from fiber-coupled light sources varies between 1 and 2%, i.e. 98% of the laser power are being reflected. Therefore, it is required to open a vapor capillary (key hole) with the beginning of the process, which increases the absorption of laser light to approx. 90%. The melting point of aluminum of 600° C. is relatively low, therefore, there exists a risk of introducing too much power into the component with opened key hole. This allows the seam to sag on the underside of the component, which in turn corresponds to a component discharge. Thus the process window is relatively small. The process window is even reduced in the event of a change in the external process conditions as well as in the case of even small changes in the gap width (max. 0.2 mm).

Additionally, aluminum in a molten state is paste-like (i.e. pasty) due to an oxide skin formed on the surface of the melt in contact with air, wherein its surface tension is decisive. This paste-like state impairs the flow of the material. Therefore, it is not sufficient to direct the processing beam onto the surface of the top sheet metal, i.e. the sheet positioned on the top during joining, in order to generate an appropriate amount of material. Due to the oxide skin the molten aluminum will not flow down to the lower sheet metal. Therefore, additional measures, which can influence the movement of the melt itself, are to be taken in order to trigger flowing of the molten, paste-like aluminum into the gap. The process parameters necessarily to be adopted for this, however, depend on each other in multiple dimensions.

Thus, especially with regard to aluminum or high-strength steels, there is the desire to use the high-performance laser-remote technique (i.e. the positioning of the processing or laser beam with highly dynamically driven deflecting mirrors), whereby the gap height (i.e. the height of a gap formed between the two workpieces to be joined at the joint) continuously is to be measured and by adapting the process parameters the gap must reliably be closed with molten material, these process parameters having to be stored in a closed control model, which is integrated into a closed, autonomously operating system with suitable dynamic properties.

### SUMMARY

The object of the invention consists in joining two workpieces at a lap joint, which exhibits a gap with varying width and height between the two workpieces running along the whole length of the lap joint, by means of a processing beam, wherein the joining process shall be influenced by an adaptation of process parameters, such that the gap present at the lap joint is being compensated completely during the joining process along its whole extension by an appropriate melting of the material. This adaptation of process parameters in order to close the gap shall be possible dynamically, automatically and continuously during the entire welding process, whereby the formation of the weld seam is to be monitored with regard to checking and possibly correcting the process parameters used.

With respect to the method this object is achieved, in accordance with the invention, by a method with the features of claim 1. With respect to the apparatus this object is achieved, in accordance with the invention, by an apparatus with the features of claim 7. Advantageous configurations of the invention are the subject-matter of dependent claims.

### DETAILED DESCRIPTION

In accordance with the invention, the method and the joining apparatus for joining a plurality of workpieces, especially those made of aluminum or high-strength steel, at a lap joint by means of a processing beam are provided. The workpieces to be joined may be e. g. sheets of aluminum. The processing beam may be e.g. a laser beam; however, it may also be provided that the processing beam generally is a beam of electro-magnetic radiation (e.g. an infra-red beam), a particle beam (e.g. an electron beam) or a sound beam (e.g. in the form of directed ultrasound).

According to the invention the compensation of a gap formed between two workpieces at a lap joint is performed by melting of material from the upper sheet, i.e. the sheet metal respectively the workpiece arranged at the upper position (with respect to the plumb line) at the lap joint during joining, using the processing beam in such a way that the gap present at the joint is filled completely with molten material flowing down or flowing in. An initially (i.e., before the beginning of the welding process) straight seam which, for example, has a larger gap in its middle, would thus have a small curvature after joining, the apex of the curvature being at the position of the largest gap due to the melting of material from the upper sheet.

According to the object a joining apparatus is provided for performing this joining method, said joining apparatus comprising a so-called remote processing optics, i.e. the (e.g. optical) elements for guiding and focusing the processing beam are designed in such a way that a large machining distance between machining optics and joint is possible, wherein particularly the movement of the processing beam (and thus the movement of a focal spot generated by the processing beam on top of the workpieces) is performed by individual movable elements driven by actuators within the processing optics, such that a unit completely comprising the processing optics (which may be enclosed by a casing) may be—except of a feeding movement—unmoved.

The purposeful melting, in particular of the upper sheet, is effected by controlling the actuators for movement integrated in the joining apparatus, power control and focusing of the processing beam, based on an adaptation of process parameters on the basis of a programmed process model which uses the type of the material, the gap height, the thickness of the workpieces and the positioning of the workpieces in the space and relative to one another as input parameter, whereby at least the determination of the gap height and component edge position is based on continuous measurements.

According to the invention it is provided to determine the gap height either directly, e. g. by means of a light-slit method, or indirectly by measuring height positions (in the vertical direction with respect to a reference position, said reference position, for example, being on the joining apparatus) of top surface sections of the workpieces (i.e. those sections of the surface which are facing upwards during joining) adjacent to the joint, wherein the height of the gap is to be calculated taking into account the thickness of the upper sheet, i.e. the workpiece, which is located on top at the lap joint during joining.

Process parameter to be adjusted for melting are: the feed rate (i.e. the speed of a relative movement between processing beam and workpieces), a spatial oscillation of the processing beam, which superimposes the feed rate (i.e. the focal spot on the weld metal sways forth and back periodically), wherein these oscillations are defined by one or more oscillation parameter, e.g. amplitude and frequency, a relative position of the focal spot with respect to the edge of a workpiece, the angle of incidence of the processing beam onto the top surface of the workpiece as well as power and focusing of the processing beam (i.e. the size of the focal spot on the top surface of the workpiece).

These process parameter may be individually or jointly target-oriented and dynamically adjusted during the welding process; that is, the process parameter can be changed during welding depending on the conditions encountered (and, for example, detected by measurements) during welding.

Since a large number of variables have to be taken into account, which may influence the flow of the melt into the gap and the complete filling thereof, including the above-mentioned process parameter, a real-time monitoring of the formed weld following the joining process is provided. Thus, the formation of the weld seam formed by the joining process is monitored for a controlled weld formation and any necessary adjustment of the process parameter during the joining process, with a view to stabilizing and / or increasing the seam quality.

The spatial oscillations (i.e. the vibration of the deflection) of the processing beam during the welding process may be performed parallel or perpendicular, preferably perpendicular, to the direction of the feed motion (i.e. the direction of relative movement of the processing beam with respect to the workpieces). For this purpose, the processing beam is being deflected in at least one of the three directions in space by means of elements for beam deflection driven by actuators arranged within the processing optics. For example, the deflection of a laser beam parallel or perpendicular to the direction of the feed motion may be caused by galvanometer scanner.

During welding, the weld pool and, if formed, the vapor capillary are moved in the direction of the feed motion along the joint of the two workpieces to be joined, wherein the vapor capillary influences the oscillatory motion of the surrounding weld pool by its own oscillations caused by the actively driven positioning of the focal spot. An important factor determining the oscillations is the material the workpieces are made of and a coating applied to any of the workpieces, respectively.

By influencing the oscillation the vapor capillary and/or the melt by means of beam oscillation, a flow of the aluminum-containing (and covered with an oxide layer) melt can be observed, which depends on the workpiece material, the gap height at the lap joint and the feed rate during welding. Additional important factors are particularly the oscillation parameter, such as frequency, amplitude and oscillation shape (e.g. sine, rectangle, triangle or saw-tooth).

Furthermore, it may be provided that the angle of incidence of the processing beam onto the surfaces of the workpieces, the focal distance and/or the collimation and thus the focusing of the processing beam are varied by means of movable, e. g. optical, elements in the remote processing optics of the joining apparatus. This makes it possible to adjust the size (i.e. the spatial extent) and the geometric shape of the focal spot on the workpiece surface as well as the power density in a targeted manner. The angular and focusing adjustment can be driven (in the axial beam direction) motorized, piezo-electrically, hydraulically or pneumatically.

The joining apparatus provided for carrying out the method according to the invention has a first sensor system for detecting the position of the joint relative to a processing head of the apparatus, and a second sensor system which is suitable for detecting (quantitatively) a distance between the upper and the lower sheet metal. It may also be provided that the first sensor system for the detection of the position of the joint and the second sensor system for the determination of the gap height are combined in a single sensor system. This sensor system comprises, for example, a projector which can project a light line at the join patch perpendicularly over the joint onto the workpiece top sides in a region in the feed direction in front of the processing beam impinging on the workpieces (i.e., the focal spot), and a digital camera, for example based on CCD or CMOS microchips, which is designed and arranged in such a way that by use of this camera images of the join patch in the region of the light line projected onto the workpiece surfaces, at least in the wavelength range of the light emitted by the projector, but preferably in the visible, near infrared and infrared wavelength range, can be taken with an image pick-up frequency of at least 50 Hz.

Furthermore, the joining apparatus provided for carrying out the method according to the invention comprises an evaluation and control unit, which is connected to the one or several sensor systems, by means of which an automated processing and evaluation of measurement data gathered by the sensor systems, which may comprise e.g. images taken by a camera, may be performed, wherein the evaluation and control unit is designed such that it may be operated by the use of software. For example, the evaluation and control unit is a computer (PC) equipped with interfaces for connecting to the sensor systems or a highly-integrated control unit with so called embedded software.

Furthermore, the evaluation and control unit has at least one (further) interface for connection to the remote processing optics of the joining apparatus and the actuator for generating the feed motion, via which a control of processing parameter of the processing beam, such as oscillation or focusing, and the feed rate are manageable. It can also be provided that the evaluation and control unit, for example for the purpose of power control, comprises an interface for connection to a processing beam generating unit which generates the processing beam.

The joining apparatus can also be designed in such a way that the position of the workpieces, that is their respective rotation about the three rotational degrees of freedom, relative to the processing head can be measured by means of one of the sensor systems. For a determination of the rotation of the workpieces relative to the plumb line, the joining apparatus may have an additional angular position sensor system, for example arranged on the processing head.

According to the invention the method for joining by means of the above described joining apparatus with adaptive adjustment of process parameter using a process model in order to improve weld seam quality during joining of a first workpiece to a second workpiece at a lap joint exhibiting a gap is carried out as follows:

The process parameter to be set during the welding process are determined on the basis of a height determination of the gap between the first and second workpiece to be joined at the joint, the material and a possible coating of the two workpieces to be joined as well as the welding feed rate to be applied. This can preferably be done by the evaluation and control unit after manually entering those input parameter which cannot be detected by the sensor systems.

The height determination of the joint gap can be effected, for example, by measuring the step height of the lap joint and subsequently subtracting the (known) sheet thickness of the upper sheet. A height measurement of the step height of the lap joint can be carried out (automatically) via laser triangulation. However, other methods for determining the height such as, for example, optical coherence tomography or evaluation of the distortion of a light line projected over the lap joint also may be used.

In a next step the process parameter, e.g. the oscillation parameter of the processing beam, the feed rate and the size of the focal spot, are set by use of the process model on the basis of the type of the material, the gap height, the thickness of the workpieces and the positioning of the workpieces in the space (i.e. with reference to the remote process optics of the joining apparatus) and relative to each other. These parameter decisively influence the size and the flow of the weld pool. In particular, it is possible, by means of a definite specification of the oscillation parameter of the processing beam, that the pasty, aluminum-containing melt is flowing from the upper sheet to the lower sheet and into the gap formed between the upper and the lower sheet by means of a resonant coupling of the processing beam oscillations into the melt waves formed on top of the weld pool. The specified set-point process parameter can differ from the actual process parameter currently used in the joining process.

In order to drive the actuators, which e.g. are located within the remote processing optics, of the joining apparatus and to control the processing beam generating unit via the evaluation and control unit a synchronization of the control signal set-points is required. For example, the power of the processing beam with a frequency of up to 8 kHz, or to the controller limit of commercially available processing beam sources, is matched with the movement of the active scanner units, the autofocuses and any additional position sensors.

The determination of the set-point process parameter according to the method can be carried out by means of the evaluation unit on the basis of a database (e.g. in the form of a so-called “look-up table”) in which, for a plurality of input parameter combinations, corresponding process parameter, which for example have been empirically determined, are stored. This database can be held in the evaluation and control unit so that the selection of the process parameter to be applied can be carried out automatically by the evaluation and control unit.

However, the determination of the set-point process parameter also may be carried out by means of an analytic function (which likewise was determined empirically by, for example, curve fitting of data collected in comprehensive experimental series). The set-point process parameter as well may be determined with the aid of a (complex) simulation model, which is stored in and run automatically by the evaluation and control unit.

Furthermore it may be provided that following up the welding process a weld seam observation and analysis is performed, which can be used for checking and, if necessary, further adjustment of the process parameter. For this purpose, the weld seam is recorded (in the feed direction) directly behind the weld pool by means of a seam quality detection sensor system, and an analysis of the weld seam quality (e.g. with respect to the seam anmutung at the seam top side, the seam overhang at the seam bottom, the topographical properties of the seam influencing its mechanical bearing strength and / or its tightness) is performed automatically. If, for example, the analysis results in an incompletely closed joint gap, an adjustment of the process parameter is carried out via the evaluation and control unit in such a way that in the further course of the welding process the joint gap again is completely filled with molten material, which is fused from the upper sheet.

Observing and analyzing the weld seam may be performed by the seam quality detection sensor system in one or in several steps. Alternatively, the observation of the weld seam may be performed using the seam quality detection sensor system, while the analysis is performed by the evaluation and control unit, which is connected to the seam quality detection sensor system.

The observation of the weld seam may be performed using a high-speed camera, which as well is sensitive in the infra-red range. The analysis may be performed automated by an image data processing software, which in real-time analyses the images of the weld seam taken by the camera with respect to characteristic fault pattern.

The advantage of the method according to the invention is that a gap, which is formed at the lap joint and has a discontinuous elevation changing in random manner along the joint, can always be closed reliably, continuously and in real-time by means of a purpose-oriented adaptation of the process parameter (such as, for example, oscillation frequency or amplitude). Since the process parameter to be applied during the welding process are continuously determined anew on the basis of the actual situation detected by means of the sensor systems, their adaptation can be carried out dynamically during the process, wherein—immanent to the process—acting to changing input parameter (such as positional changes of the workpieces relative to each other at the weld seam) is also possible in real time.

Another advantage of the method according to the invention is its high degree in automatization, such that only at the beginning of the welding process a (manual) input of values influencing the joining process, like material composition of the workpieces or sheet thickness, into e.g. the evaluation and control unit is required.

By means of an observation and analysis, respectively, of the weld seam, which is following up the welding process, an instantaneous correction of the set-point process parameter to be applied is possible in the case the weld seam analysis reveals a deteriorating weld seam quality, which in turn guarantees a permanent constant high quality of the weld seam.

By means of the method according to the invention the efforts for part preparation may be reduced considerably. Furthermore, the clamping device, which is pressing the workpieces to be joined against each other, may be simplified and the clamping device does not need to be positioned with the usually required precision, respectively, in order to fasten the workpieces to each other with a small, constant gap or even gapless. Therefore, cycle times can be reduced significantly and costs are saved.

The joining apparatus according to the invention unites acquisition of measurement values and control of all required actuating variables in one device. The joining process may run completely automated, i.e. no further external measures are to be initiated.

It may be provided that the oscillation of the processing beam, i.e. the temporal curve progression of the oscillation amplitude, shows the shape of a sine, a triangle (saw-tooth), a rectangle or any other function of a higher order, to adapt the power distribution to the structural condition of the component.

According to an embodiment of the method an evolutionary algorithm may be used to apply a required correction to the set-point process parameter, which became evident by the following-up observation and analysis of the weld seam. This evolutionary algorithm permits a (re-)combination of input parameter and measurement values, respectively, preferably of the gap height, with process parameter to be applied on the basis of good welding results. In this way, a learning system is built, wherein permanently reacting to changing influences is made possible. These newly-collected parameter combinations may be permanently stored in a database, which is stored in the evaluation and control unit, or may be stored only during the time period of the welding process in a storage area separate from the database. By this unlimited flexibility of the method each process parameter may be adjusted dynamically during the welding process depending on the quality of the weld seam generated by the welding.

It may be provided, too, that during the welding due to (external) process-related requirements to change the feed rate the process parameter (with the exception of the feed rate) are selected as a function of the changed feed rate, i.e. the feed rate is treated as a fixed process parameter while during the welding process the remaining process parameter can be adapted to a feed rate changing due to external specifications.

According to an embodiment a short-term pulse is modulated on top of the processing beam in order to improve flowing properties of an aluminum-containing melt and to temporarily remove an oxide skin formed on the surface of the melt, i.e. the process beam being continuously emitted form the process beam generation unit is enhanced pulse-like (in its power). In this case it can be provided that the pulse impinges on the workpiece surface during the welding process at the same working location of the continuously emitted processing beam, or that the processing beam for the duration of the pulse is deflected to a position on the workpiece surface, which is located in the direct vicinity of the working location of the weld seam generation, wherein the distance preferably is less than 4 mm.

### BRIEF DESCRIPTION OF THE DRAWINGS

An exemplary embodiment of the invention will be described in more detail below on the basis of the drawings. Shown therein are:

FIG. 1 a schematic representation of a joining apparatus in a cross-sectional view with the lap joint in longitudinal-sectional view;

FIG. 2 a schematic representation of the lap joint in cross-sectional view with the processing beam oscillating perpendicular to the lap joint; and

FIG. 3 an intensity distribution of the processing beam at the position of the focal spot oscillating perpendicular to the lap joint.

### DETAILED DESCRIPTION OF THE PREFERRED EMBODIMENTS

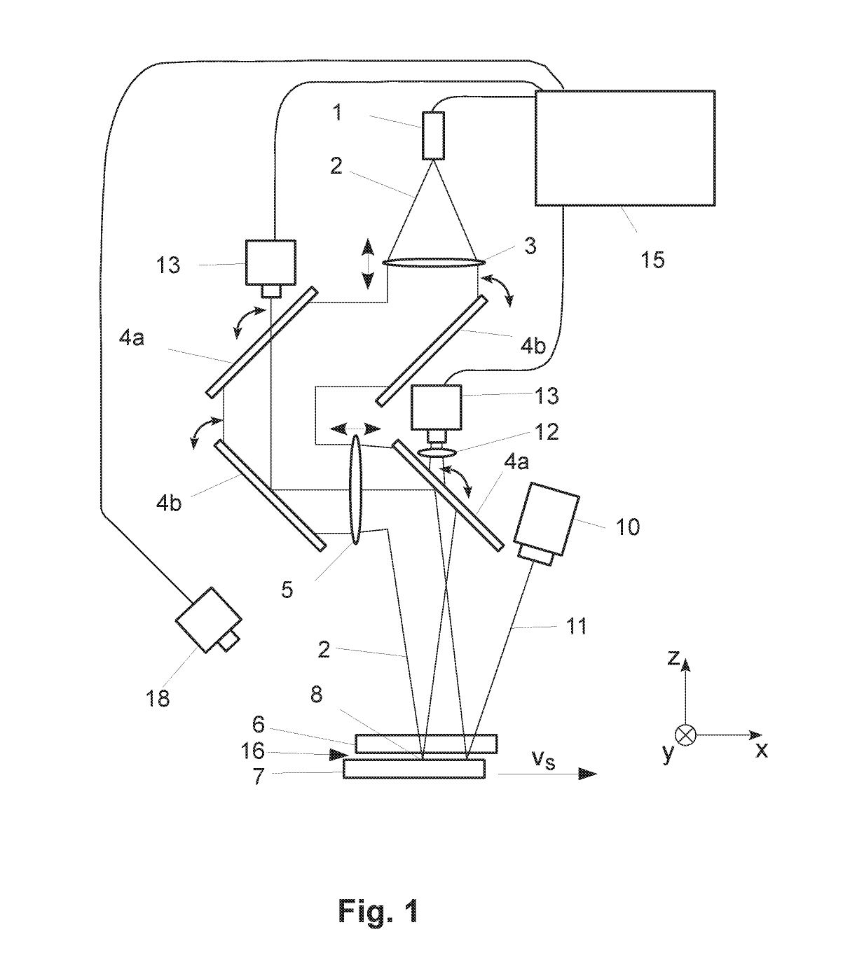

In FIG. 1 a laser beam welding apparatus with remote laser processing optics is represented; thus, the processing beam is a laser beam. The laser beam generation unit 1 generates the laser beam 2, which collimates from the collimation unit 3, which can be moved along the beam axis, onto the deflection units 4a, which oscillate about their respective cross axes, and the deflection units 4b, which oscillate about their longitudinal axis. Eventually, the focusing unit 5 generates the laser focal spot 8 on the surface of the workpieces 6 (upper sheet) and 7 (lower sheet), said focal spot 8 being moved along the lap joint at a feed rate Vₛ.

A projector 10 projects on the surface of the workpieces by means of the measurement light 11 a light line, which is running perpendicular across the lap joint. Sensors 13 detect the light line, wherein a sensor focusing 12 unit may be connected ahead of the sensor 13. An evaluation and control unit 15 connected to the sensors calculates from their collected data an exact position of the joint, a position of the workpieces 6 and 7 with respect to each other (and which of the two workpieces is the upper sheet 6) as well as a height of a gap 16 between the two workpieces 6 and 7 at the joint.

A seam quality detection sensor system 18 generates a snapshot of the weld seam behind the laser focal spot 8 with respect to the direction of the feed motion (x). These snapshots are processed by the evaluation and control unit 15, wherein upon first signs of a deteriorating quality of the weld seam the process parameter are adjusted according to a process model stored in the evaluation and control unit 15 specifically to the detected signs.

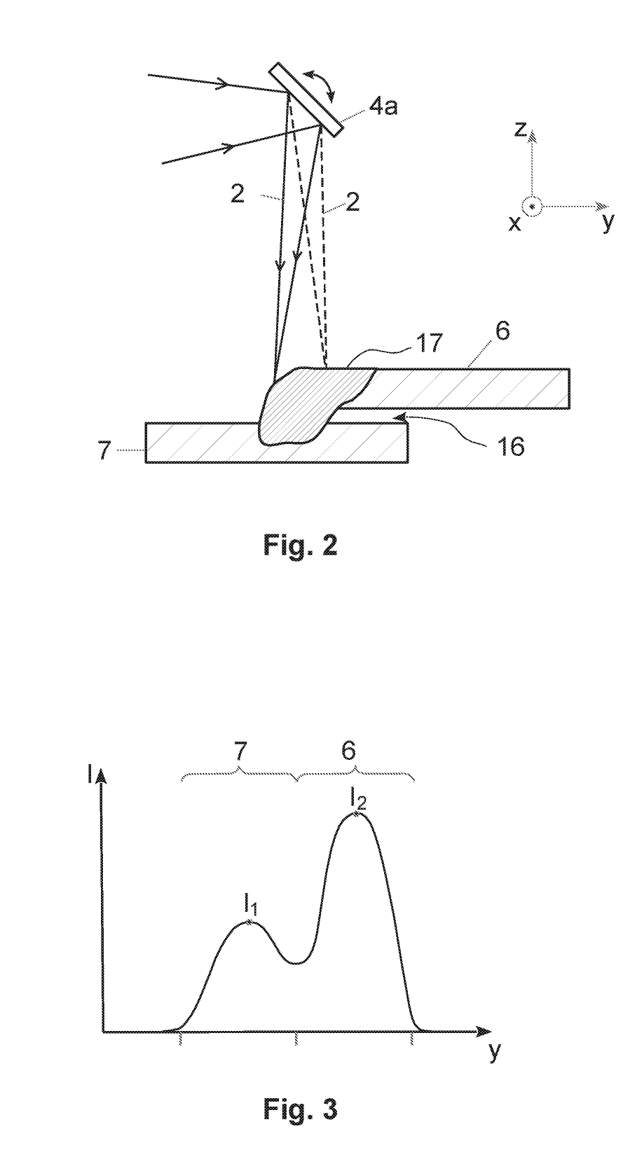

The deflection units 4a, represented schematically in FIG. 2, of the remote laser processing optics allow—driven by the evaluation and control unit 15—for an oscillatory movement of the laser beam 12 across the lap joint in a way that the upper sheet 6, which consists from the material aluminum, is fused, so as to form the weld pool 17. Additionally, the oscillation parameter are adjusted in such a way that at least a part of the pasty weld pool 17 is flowing down onto the lower sheet 7 and thus closing the gap 16.

An intensity distribution of the laser focal spot 8 created on the surfaces of the workpieces is represented in FIG. 3. The oscillations of the laser beam 2 (and accordingly the laser focal spot 8) are set such that the maximum I₂ of the intensity I, which is introduced into the surfaces of the workpieces by the laser beam 2 in a direction perpendicular to the joint, is located on the upper sheet 6. A secondary local maximum I₁ of the intensity I is located on the lower sheet 7.

### LIST OF REFERENCE NUMERALS

1 Processing laser
2 Laser beam
3 Collimation unit
4a Deflection unit, oscillating about its cross axis
4b Deflection unit, oscillating about its longitudinal axis
5 Focusing unit
6 Workpiece (upper sheet)
7 Workpiece (lower sheet)
8 Laser focal spot
10 Projector
11 Measurement light
12 Sensor-focusing unit
13 Sensor
15 Evaluation and control unit
16 Gap
17 Weld pool
18 Seam quality detection sensor system
vs Feed rate
I Intensity
x x-direction/direction of the feed motion
y y-direction/direction perpendicular to the feed motion
z z-direction/plumb line

what is claimed is:

1. A method for joining workpieces by means of a processing beam (2) of a joining apparatus, comprising processing optics with actively driven deflection units for guiding the processing beam (2) and with at least partially movable optical elements for focusing the processing beam (2) onto a surface of a first (6) and/or a second (7) of said workpieces to be joined, said method comprising a joining of the first (6) to the second (7) workpiece at a lap joint by generating a spatially confined weld pool (17) using said processing beam (2), wherein
the processing beam (2) performs during joining a spatially oscillating movement defined by oscillation parameter,
one or more height positions with respect to the plumb line are captured for both, the first (6) and the second (7) workpiece, each at a top surface section of said workpieces (6, 7) adjacent to a processing position at the lap joint to be processed by the processing beam (2),
said height positions are evaluated with regard to determining a height difference between the top surface sections of the first (6) and the second (7) workpiece adjacent to the processing position at the lap joint, and
an energy input of the processing beam (2) into the top surface section of the workpiece, which is located at a higher position at the processing position, is increased with an increasing height difference at the lap joint and is decreased with a decreasing height difference said method for joining being characterized in that
a determination of a position of the lap joint, of the first (6) and of the second (7) workpiece is carried out;
setting of a plurality of process parameter, including the oscillation parameter of the spatially oscillating movement as well as a defocusing of the processing beam (2), occurs based on a programmed process model, which at least depends on a material composition of the workpieces (6, 7) to be joined, the thicknesses of the workpieces (6, 7) as well as a continuously during joining determined height of the gap (16) and positioning of the workpieces (6, 7) in space and relative to each other,
wherein at least one oscillation parameter of the oscillating movement of the processing beam (2) is set in such a way that the oscillations of the processing beam (2) couple into melt waves formed on the surface of the weld pool (17) so that molten material flows from the weld pool (17) at the processing position into a gap (16) formed between the two workpieces (6, 7) at the lap joint.

2. The method as claimed in claim 1, characterized in that said height positions are measured using a light-slit method, wherein at least one measuring line projected onto the component is recorded by means of a camera and the distortion of the measuring line with respect to a determination of the height positions of the top surface sections of the first (6) and the second (7) workpiece adjacent to the processing position is evaluated.

3. The method as claimed in claim 1, characterized in that said height positions are measured based on a runtime measurement of laser light, wherein a running time of said laser light from a laser light emitter to the respective measuring position is detected for a plurality of measuring positions on the top surface sections of the first (6) and the second (7) workpiece, and the orientation of the top sections in space and the height difference between the top surface sections of the first (6) and the second (7) workpiece adjacent to the processing position are determined by evaluating runtime differences.

4. The method as claimed in claim 1, characterized in that said process parameter comprise oscillation parameter of the oscillating movement of the processing beam (2), a feed rate (Vs), a power of the processing beam (2), oscillations of the power of the processing beam (2), an angle of the beam axis of the processing beam (2) with respect to the plumb line (z), a geometric shape and a size of a focal spot (8) of the processing beam (2) on the workpiece surfaces.

5. The method as claimed in claim 1, characterized in that the oscillation parameter to be adjusted comprise an amplitude of the spatial oscillations of the processing beam (2) and/or a frequency of oscillation and/or a shape of the oscillations.

6. The method as claimed in claim 1, characterized in that quality values, which characterize the quality of the weld seam formed, are detected in the feed direction (x) immediately behind the processing beam (2) by means of an optically operating seam quality detection sensor system (18) and are evaluated with regard to a deteriorating quality, wherein a deteriorating quality is compensated by adjusting individual or several process parameter.

7. A joining apparatus for joining a first workpiece (6) to a second (7) workpiece at a lap joint by means of a processing beam (2) according to the method as claimed in claim 1, comprising a processing beam generation unit (1), a remote processing optics with scanning devices (4a, 4b ) for guiding the processing beam (2) and with at least partially movable optical elements (3, 5) for focusing the processing beam (2) onto the surface of the first (6) and/or the second (7) of the workpieces to be joined, sensor systems to determine a respective position of the lap joint, of the first (6) and of the second (7) workpiece, and an evaluation and control unit (15), which is connected to the sensor systems, the processing beam generation unit (1) and the remote processing optics, wherein said evaluation and control unit (15) is configured in such a way that the remote processing optics and the processing beam generation unit (1) are controllable on the basis of a programmed process model stored in the evaluation and control unit (15), wherein said programmed process model at least depends on a material composition of the workpieces (6, 7) to be joined and the thicknesses of the workpieces (6, 7) to be entered before starting the process, as well as a height of the gap (16) at the lap joint between the first (6) and the second (7) workpiece and a positioning of the workpieces (6, 7) in space and relative to each other, said height of the gap (16) and positioning of the workpieces (6, 7) being determined by the use of measurement values gathered by the sensor systems.

8. A joining apparatus as claimed in claim 7, characterized in that a database containing a plurality of default values of process parameter is stored in the evaluation and control unit (15), wherein each process parameter is assigned an input parameter or a combination of said input parameter, said input parameter comprising a material composition of the workpieces (6, 7) to be joined, a height of the gap (16), a thickness of the workpieces (6, 7) and a positioning of the workpieces (6, 7) relative to each other and/or in space defined by six degrees of freedom.

9. A joining apparatus as claimed in claim 7, characterized in that said joining apparatus comprises angle sensors for determination of a tilt of the top surface sides of the first (6) and/or the second (7) workpiece with respect to a processing head of the joining apparatus, said processing head comprising the remote processing optics.

10. A joining apparatus as claimed in claim 7, characterized in that said joining apparatus comprises a seam quality detection sensor system (18) connected to the evaluation and control unit (15), said seam quality detection sensor system (18) being capable of detecting in real time the weld seam behind the weld pool (17) with respect to the feed direction.
